(19) United States
(12) Patent Application Publication
(10) Pub. No.: US 2007/0234633 A1
(43) Pub. Date: Oct. 11, 2007

(54) Thunder buzz fishing lure

(76) Inventors: Jimmie W. Uselman II, Salem, IL (US); Brandie R. Uselman, Salem, IL (US)

Correspondence Address: Jimmie W. Uselman, 110 S Pruyn, Salem, IL, 62881, US

(21) Appl. No.: 11/397,383

(22) Filed: Apr. 5, 2006

(51) Int. Cl. A01K 85/10; A01K 85/00

(52) U.S. Cl. 43/42.13; 43/42.19; 43/42.2

(57) ABSTRACT

The Thunder Buzz fishing lure utilizes similarities and differences of the Buzz bait fishing lure (U.S. Pat. D468,794). The differences being a rotating spinner blade, a couple, and two wires of different size. Provided in this application are application transmittal form, fee transmittal form, application data sheet, specification, drawings, photographs and oath.

### REFERENCE CITED

| | | | |
|---|---|---|---|
| 4201008 | May, 1980 | Sparkman | 43/43 |
| 4510710 | April, 1985 | Hanna et al. | 43/42 |
| 4793089 | December, 1988 | Long et al. | 43/42 |
| 4823501 | April, 1989 | Standish, Jr. | 43/42 |
| D381061 | July, 1997 | Graham | D22/129 |
| 849036 | April, 1907 | Zimmerman | |
| 967660 | August, 1910 | Pedersen | 43/42 |
| 1395533 | November, 1921 | Tuttle | 43/42 |
| 1627637 | May, 1927 | Dahlquist | |
| 1804391 | May, 1931 | Abrahams | 43/42 |
| 2167945 | August, 1939 | Gilliam | 43/42 |
| 2261433 | November, 1941 | Demory | 43/42 |
| 2266234 | December, 1941 | Mitchell | 43/42 |
| 3093923 | June, 1963 | Jackson | 43/42 |
| 4011681 | March, 1977 | Johnson | 43/42 |

### BACKGROUND OF THE INVENTION

This invention relates to the fishing lure and spinner (U.S. Pat. No. 4,201,008) and the Buzz bait fishing lure (U.S. Pat. D468,794). Being a fisherman myself, it is hard to go to a high pressured lake and catch a fish without a hold already in it's mouth. Every spring, manufacturers spend millions of dollars trying to come up with the next “hot” bait and something fish haven't seen before. The lures that worked fifteen years ago are starting to become “hot” again today simply because this generation of fish haven't seen them before.

Fishing the Buzz bait fishing lure is one of my favorite lures to fish. There is nothing like retrieving the lure across the top of the water with it flashing and bubbling, anticipating that surface explosion when a fish bites it! It has been known to draw fish from as far away as 30 feet.

The Buzz bait fishing lure retrieval speed is what determines the rhythmic sound of the bubbles on the surface drawing the attention of the fish to the lure. The fish then turns toward the skirt end and classifies it as food. The fish then bites at the skirt and is caught by a protruding hook that is being concealed by the skirt.

The Thunder Buzz fishing lure utilizes the Buzz bait fishing lure concept but takes it to a whole new level of properties. While the Buzz bait fishing lure has one uniform of motion, the Thunder Buzz fishing lure has many.

Although the Thunder Buzz fishing lure also uses the retrieval speed to produce rhythmic sound bubbles and hook-n-skirt, it does not rely on these characteristics alone. As the Thunder Buzz fishing lure is retrieved through the water, the propeller is rotating making the rhythmic sound bubbles on the surface. The spinner blade (copper is used when the water is murky with overcast conditions, silver is used when the water is clear with sunny conditions) is rotating behind the propeller giving the lure flash. With the spinner blade rotating at the waters surface, it is able to flash under the water a few times then rotate and skip on the waters surface. The flash catches the fish's eye and skipping action represent the bait fish shad (a main food source of the large mouth bass). The water behind the propeller will then catch the spinner blade and start the cycle underneath the water again. The propeller-spinner blade end is assembled using a larger diameter of wire for reasons being strength and structure endurance, hook sets, casting ability, and creating a strong point for which the hook-skirt end is coupled.

In the meantime, the hook-skirt end is “dancing” free under the waters surface because it is not stationary due to a couple connecting it to the propeller-spinner blade end. The couple gives it freedom to rotate 15 degrees either right or left, and side to side creating a “rocking” motion as it is retrieved through the water. The hook-skirt end is mounted using a smaller diameter of wire which gives it flexibility to move independently with the propeller-spinner blade end by the use of a couple. All these differences are aimed at giving the lure the freedom to move independently thus creating a lure with more attracting abilities. The Buzz bait fishing lure field of search utilizes 43/42.51, 42.11, 42.13, 42.14, 42.31, 42.28, 42.2, 42.27. The Thunder Buzz fishing lure utilizes all of these field of search along with 42.12, 42.15, 42.16, 42.19.

I have tested the Thunder Buzz fishing lure against the Buzz bait fishing lure. I used two different rods and reels, one with the Thunder Buzz fishing lure and the other with the Buzz bait fishing lure. I preceded to cast one then the other, alternating each cast to the same spot in the pond. The Thunder Buzz fishing lure prevailed versus the Buzz bait fishing lure catching 2 to 1.

### BRIEF SUMMARY OF THE INVENTION

As the Thunder Buzz fishing lure is being retrieved across the waters surface, the fishermen can observe the propeller rotating causing a wake of bubbles. The spinner blade rotates upward and skips across the waters surface for a few seconds then rotates downward underneath the water. These two items create a bubbling-splashing sound that can be heard from a distance.

Underneath the waters surface, the spinner blade flashes its color from the light source above by being mounted loosely to the clevis that supports it. The hook-skirt end is in motion trailing the propeller-spinner blade end with its life like appearance. The hook-skirt end is able to move freely by the use of a couple and a smaller diameter size of wire. As it is trailed through the water, the hook-skirt end can move independently creating a “rocking” or side to side effect causing the lure to appear life-like. The idea behind the Thunder Buzz fishing lure is to allow the fish to be drawn to the lure by the splashing and bubbling sounds and appear life-like once the fish gets there so it may be caught.

### BRIEF DESCRIPTION OF THE DRAWING

In the drawing,

FIG. 1 is the left side elevation view of the Thunder Buzz fishing lure (the right side view is a mirror image of the left side view);

FIG. 2 is a three dimensional top view of the Thunder Buzz fishing lure rotated 15 degrees displaying both top and bottom structure;

FIG. 3 is a spinner blade (shown as a willow leaf) connected by a clevis that rotates around a wire between two ball bearings;

FIG. 4 is two different size wires (A being 0.035 and B being 0.030) joined by looping A end of wire with B end of wire. A end coupled with A and B end coupled with B;

FIG. 5 is the left side elevation view showing an embodiment of an already claimed design (the right view is a mirror image of the left view).

### DETAILED DESCRIPTION OF THE INVENTION

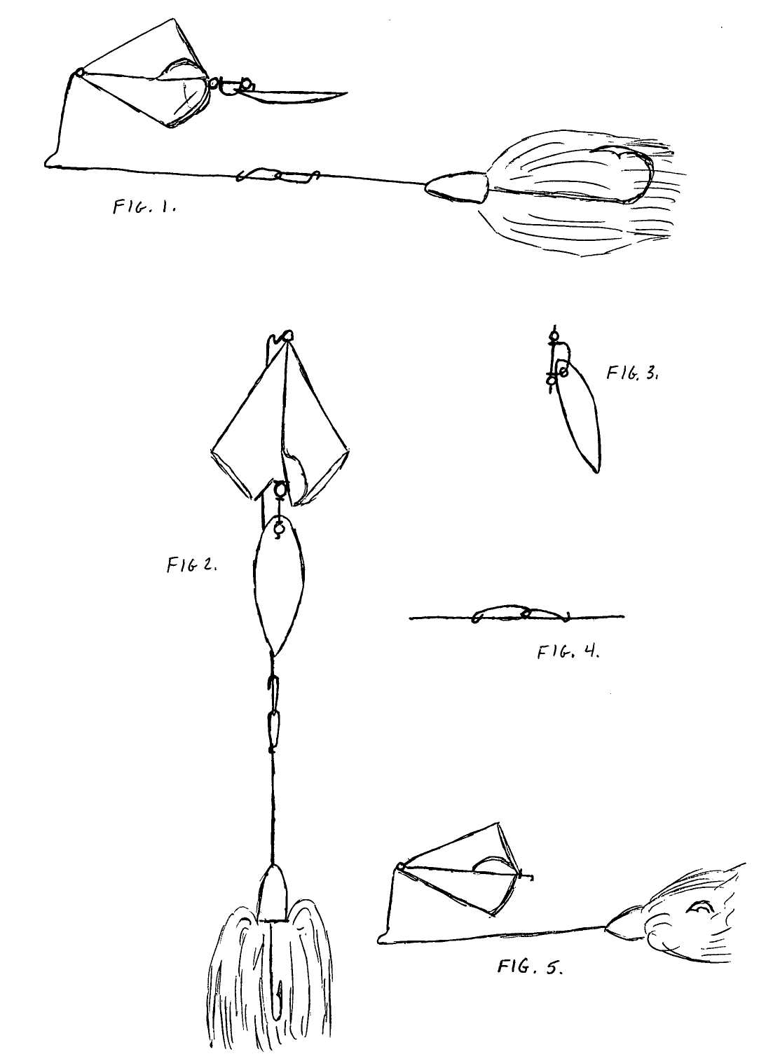

Referring to the drawing FIG. 1, it is being described as it is viewed from the left side (the right side is a mirror image to the left side). FIG. 1C is an 0.035 gauge wire that is made using four bends. The top horizontal axis is a length of wire which supports in order from the bend (left to right); one ball bearing, one propeller, one ball bearing, a clevis with a spinner blade attached through the spinner blade hole, one ball bearing, and the end of wire bent downward sharply at a 90 degree angle as a way of keeping all items attached. The spinner blade is mounted to the clevis with the convex side projecting away from the axis. The vertical axis has two bends in the bottom section for the use of a line tie. The bottom horizontal axis is a length longer than the top horizontal axis and has a couple on the opposite end of the line tie. The vertical axis produces a distance in which the propeller blade can rotate on the top horizontal axis without interference from the bottom horizontal axis. FIG. 1D is an 0.030 gauge wire with a couple on the left end to which is coupled to FIG. 1C. It is a horizontal axis to which a hook is fastened with lead being of a cone shape covering the hook-wire conjunction. A skirt made of rubber/silicone (can be of different colors) is attached covering the exposed hook.

FIG. 2 is a top view showing the same characteristics described in FIG. 1, FIG. 1C, and FIG. 1D. In FIG. 2 the emphasis is shown in the couple. FIG. 1C couple is shown in a vertical state. FIG. 1D couple is shown in a horizontal state. The loose fitting couple can also be seen.

FIG. 3 is a top view showing a wire with one end bent to secure attached items. On the wire in order from top to bottom are; one ball bearing, one clevis in which a spinner blade is mounted using a hole at one end, and a ball bearing.

FIG. 4 is a view from the left side showing FIG. 4A being a larger diameter of wire with a coupled end and FIG. 4B being a smaller diameter of wire with a coupled end. The two wires are shown as being passed through each other and then coupled together.

FIG. 5 is a view from the left side of the Buzz bait fishing lure (U.S. Patent D468,794) with the right side view being of mirror image to the left side. The single wire is bent four times creating a top horizontal axis, a vertical axis, and a bottom horizontal axis. A line tie joins the vertical axis with the bottom horizontal axis. The top horizontal axis is length of wire which supports in order from the bend (left to right); a propeller, one ball bearing, and a bend to secure attached items. The vertical axis is a length of wire being a distance in which the propeller on the top horizontal axis can rotate without interference from the bottom horizontal axis. The bottom horizontal axis (from left to right) has a line tie with a length of wire to which a hook is fastened with lead being of a cone shape covering the hook-wire conjunction. A skirt made of rubber/silicone (can be of different colors) is attached covering the exposed hook.

I claim:

1. The spinner blade mounted behind on the same axis as the propeller will be free to rotate creating flash and action both in and on top of the water.

2. The coupling of two wire (FIG. 4A being aligned with y-axis and FIG. 4B being aligned with x-axis) create a joint that enables the propeller-spinner blade end to move independently with the hook-skirt structure while in the water. The hook end structure is able to move side to side as well as up and down and even “rock” or “walk” (the top of the hook-skirt structure rotating 15 degrees right or 15 degrees left of center point).

3. The use of two wires being of different size allow the propeller-spinner blade end (FIG. 1C) a stronger axis while the hook-skirt structure (FIG. 1D) is granted flexibility creating a streamline effect.
